(19) United States
(12) Patent Application Publication
(10) Pub. No.: US 2020/0272412 A1
(43) Pub. Date: Aug. 27, 2020

(54) METHOD AND APPARATUS FOR SEARCHING A LIST

(71) Applicant: MOTOROLA SOLUTIONS, INC, Chicago, IL (US)

(72) Inventors: MING YEH KOH, BDR BARU AIR ITAM (MY); SYED ISA SYED IDRUS, BAYAN LEPAS (MY); BING QIN LIM, JELUTONG (MY); SOON HOE LIM, IPOH (MY)

(21) Appl. No.: 16/286,846

(22) Filed: Feb. 27, 2019

(51) Int. Cl. G06F 3/16; G06F 3/0488; G06F 3/0482

(52) U.S. Cl. CPC G06F 3/167; G06F 3/0482; G06F 3/04883

(57) ABSTRACT

A method and apparatus for initiating a search of material displayed on a touch screen is provided herein. During operation, a speed of a scroll of the material is measured. Based on the speed of the scroll, a voice-search function will be initiated on a material.

### BACKGROUND OF THE INVENTION

Touch-sensitive displays (also known as “touch screens”) act as a user interface, and are well known in the art. Touch screens are used in many electronic devices to display control buttons, graphics, text, and to provide a user interface through which a user may interact with a device. A touch screen detects and responds to contact on its surface. A device may display documents such as lists, file folders, thumbnails, . . . , or other scrollable material on a touch screen. A user may scroll through the scrollable material by contacting the touch screen at various locations and swiping up, down, left, and/or right.

A conventional user interface often has a search button at the top or bottom of touch screen, which may be difficult for users to access with single-handed operation. Additionally, when a user needs to perform a quick search of a document, they might find it takes a lot of time to browse through the document to find the searched-for item in the document. Using voice control to search the document will be the most convenient, however, it is often time consuming to access a voice-control or speak a wake word to trigger voice control (e.g. “Hi Siri”, “OK Google”, “Hi Bixby”). Because of this, it would be beneficial if there existed a quicker way to search documents on a touch screen.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1a, FIG. 1b, and FIG. 1c shows a general operational environment, according to one embodiment of the present invention;

FIG. 2 is a block diagram showing a device for searching a list.

FIG. 3 is a flow chart showing operation of device of FIG. 2.

FIG. 4 is a flow chart showing operation of device of FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need a method and apparatus for initiating a search of material displayed on a touch screen is provided herein. During operation, a speed of a scroll of the material is measured. Based on the speed of the scroll, a voice-search function will be initiated on the material.

It should be noted that for simplicity, the term “material” is used when describing the invention in many places. The term “material” encompasses any scrollable material such as, but not limited to a document, an image, a video, a list, a file folder, an audio file, . . . , etc. Therefore, substitution of the term “material” with the term “document”, “image”, “video”, “list”, “file folder”, “audio file”, . . . , etc. may take place below without varying from the scope of the invention as the present invention is meant to encompass searching of multiple lists, images, video, . . . , etc. as described below. As long the material being displayed is scrollable, a search of the material may take place as described herein.

Expanding on the above, when a device detects a fast scrolling action on material displayed on a touch screen, a voice-control mode is auto activated to receive voice input for a search term (for example, a desired search name such as “Smith”). The device will attempt to find the search term within the material. If the term is detected within the material, the screen will then auto scroll the material so that the term is shown in the middle of the screen and potentially highlighted.

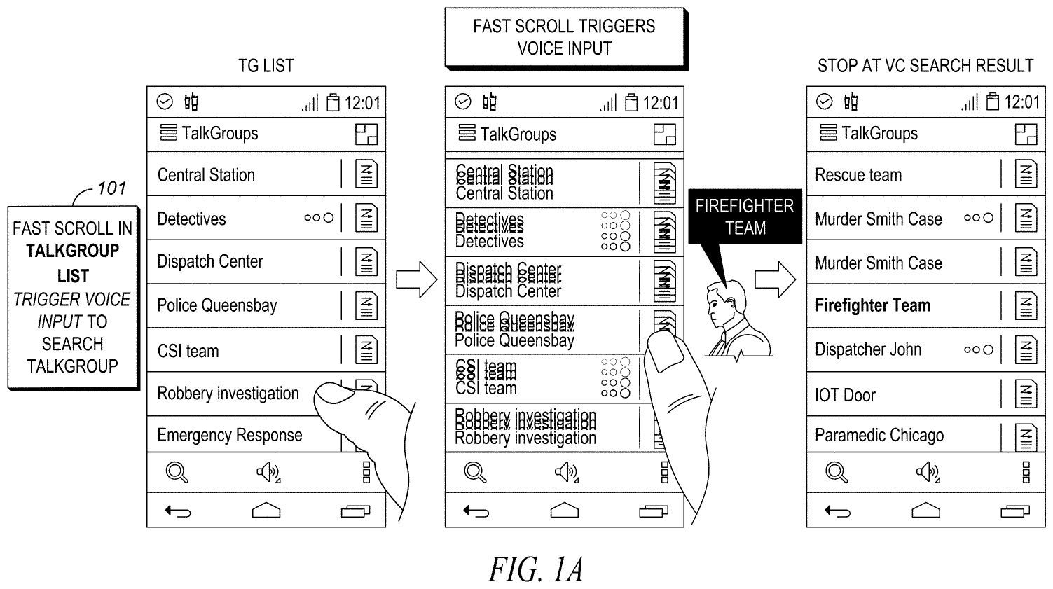

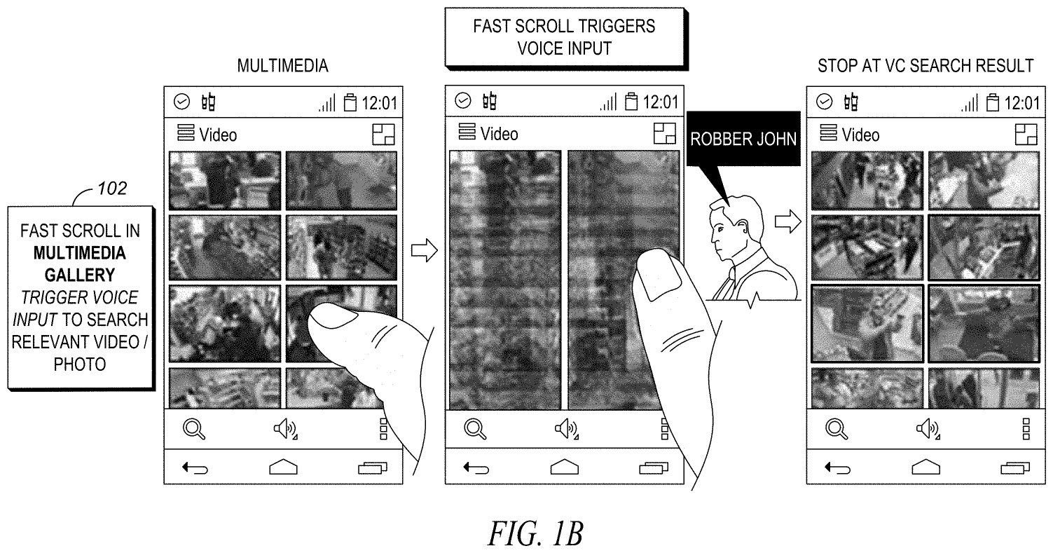

Consider the three examples shown in FIG. 1a, FIG. 1b, and FIG. 1c. In a first example 101, a touchscreen displays a list of talkgroups on a police radio. In this example, a fast scroll of the talkgroup list triggers a voice input (the radio listens for a search term). When the user states, “Firefighter Team”, the radio searches for that term, finds it, and scrolls to the appropriate place in the talkgroup list where “Firefighter Team” is located, and positions it on touch screen (in this case approximately centered on touch screen). The Fire Fighter Team talkgroup may be highlighted.

In a second example 102, a touchscreen displays a list of multimedia, shown as thumbnail images on a police radio. In this example, a fast scroll of the thumbnails list triggers a voice input (the radio listens for a search term). When the user states, “Robber John”, the radio searches for that term, finds related thumbnails (e.g., thumbnails related to the term “robber” and “John”), and scrolls to the appropriate place in the list of multimedia where the related images are located, and positions the images on touch screen (in this case approximately centered on touch screen).

In a third example 103, a touchscreen displays a list of messages in a messaging application on a police radio. In this example, a fast scroll of the messages triggers a voice input (the radio listens for a search term). When the user states, “Nicholas Wong”, the radio searches for that term, finds it, and scrolls to the appropriate message where a message from Nicholas Wong is located, and positions it on touch screen (in this case approximately centered on touch screen).

It should be noted that there may exist material where a similar entry appears multiple times within the material. For example, consider example 103 above. Multiple messages from Nicholas Wong may exist within the list of messages. In this case, stating “Nicholas Wong” will scroll the list to the first instance of the search term within the list. If another fast scroll is initiated, and the same search term is mentioned (i.e., “Nicholas Wong”), then the list will be scrolled to the next instance of the search term. The above process may be repeated.

It should be noted, that the process of scrolling material on a touch screen entails a user swiping the touchscreen in a particular direction while the at least a portion of the material is displayed on the touchscreen. The swipe speed dictates how fast the scrolling takes place, while the direction of the swipe determines which way a material is scrolled (left, right, up, down). A swipe involves quickly moving (or “swiping”) your finger across a touchscreen or trackpad. For example, swiping the screen from right to left in a photo viewing application typically displays the next photo that exists to the right of the currently-displayed photo. While browsing multiple photos, swiping up or down may allow you scroll through the photo library.

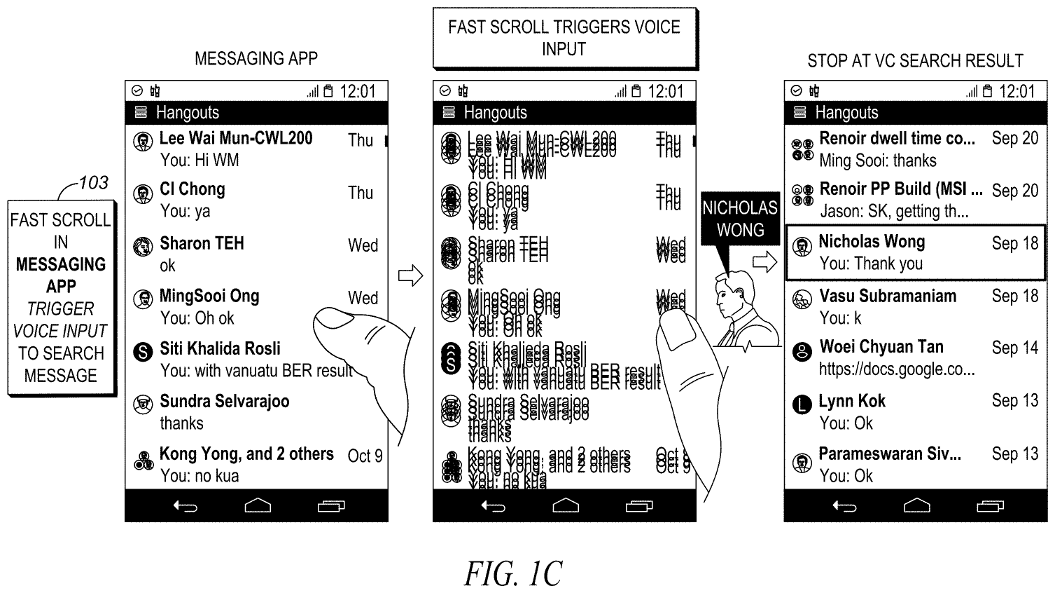

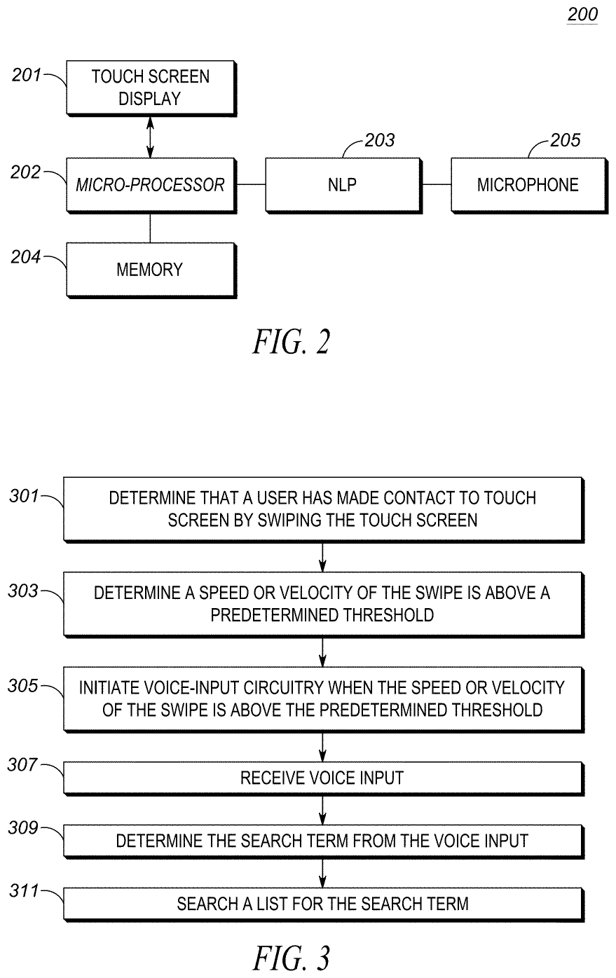

Turning now to the drawings, where like numerals designate like components, FIG. 2 is a block diagram of a portable electronic device 200 that preferably comprises a touch screen 201. Device 200 includes a memory 204, one or more processing units (CPU's) 202 (sometimes referred to as logic circuitry), microphone 205, touch screen 201, and natural-language processor (NLP) 203. These components communicate over the one or more communication buses or signal lines (not labelled in FIG. 2). Device 200 can be any portable electronic device, including but not limited to a handheld computer, a tablet computer, a mobile phone, a police radio, a media player, a personal digital assistant (PDA), or the like, including a combination of two or more of these items. It should be appreciated that device 200 is only one example of a portable electronic device 200, and that device 200 may have more or fewer components than shown, or a different configuration of components. The various components shown in FIG. 2 may be implemented in hardware, software or a combination of both hardware and software, including one or more signal processing and/or application specific integrated circuits.

Memory 204 may include high speed random access memory and may also include non-volatile memory, such as one or more magnetic disk storage devices, flash memory devices, or other non-volatile solid state memory devices. In some embodiments, memory 204 may further include storage remotely located from the one or more processors 202. Memory 204 stores scrollable material.

Microphone 205 provides an audio interface between a user and device 200. Microphone 205 receives audio signals and converts them to appropriate electrical signals. NLP 203, and ultimately Logic circuitry 202 receives electrical signals converted by the microphone 205 from sound waves.

Touch screen 201 provides both an output interface and an input interface between device and a user. Logic circuitry 202 also serves as a touch-screen controller, and receives/sends electrical signals from/to touch screen 201. Touch screen 201 displays visual output to the user. The visual output may include text, graphics, lists, video, and any combination thereof.

Touch screen 201 also accepts input from the user based on haptic and/or tactile contact. Touch screen 201 forms a touch-sensitive surface that accepts user input. Touch screen 201 and logic circuitry 202 (serving as a touch screen controller) detects contact (and any movement or break of the contact) on touch screen 201 and converts the detected contact into interaction with user-interface objects, such as material displayed on touch screen 201. In an exemplary embodiment, a point of contact between touch screen 201 and the user corresponds to one or more finger digits of the user.

Touch screen 201 and logic circuitry 202 may detect contact and any movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 201. The touch-sensitive display may be analogous to the multi-touch sensitive tablets described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1. The user may make contact with touch screen 201 using any suitable object or appendage, such as a stylus, finger, and so forth.

In some embodiments, in addition to touch screen, device 200 may include a touchpad (not shown) for scrolling through material. In some embodiments, the touchpad is a touch-sensitive area of device that, unlike touch screen, does not display visual output. The touchpad may be a touch-sensitive surface that is separate from touch screen 201 or an extension of the touch-sensitive surface formed by touch screen 201.

Logic circuitry 202 detects contact with touch screen 201. Logic circuitry 202 includes various software components for performing various operations related to detection of contact with touch screen 201, such as determining if contact has occurred, determining a speed of any contact with touch screen, determining if there is movement of the contact and tracking the movement across touch screen, and determining if the contact has been broken (i.e., if the contact has ceased). Determining movement of the point of contact may include determining speed (magnitude), velocity (magnitude and direction), and/or an acceleration (including magnitude and/or direction) of the point of contact.

Logic circuitry 202 maps the speed (and/or velocity, for ease of explanation, the speed will be used below, but one of ordinary skill in the art will recognize that a velocity (speed plus direction of swipe) may be used as well) of the swipe on a list to a voice-input state (i.e., whether or not to receive a voiced search term). The mapping process preferably comprises an operation that associates each element of a given set (the domain) with one or more elements of a second set (the range). The swipe speed within the scrollable material comprises the domain, while the voice input state (i.e., whether to receive or to not receive voice input) comprises the range. The mapping may be explicit based on predefined rules, or the mapping may be trained via neural network modeling. The mapping produces the voice input state; to receive, or not to receive a voiced search term.

As discussed, logic circuitry 102 will map the scroll speed to a voice-input state. More specifically, if scroll speed x is an element of a group of possible scroll speeds X (i.e., x∈X), we say that f “takes the value” or “maps to” f(x) at x. The set X is called the domain of the function f. The set of possible outcomes of f(x) is called the range (to receive, or not receive a voiced search input). The mapping process preferably comprises an operation that associates each element of a given set (the domain) with one or more elements of a second set (the range). For example, y=F(x), where y is the range and x is the domain. If y is the voice input state (range) and scroll speed comprises the domain, then:

Voice Input State=Function (Scroll Speed).

Initiating a search from a voiced input depends on the speed or velocity of the swipe. For example, when the swiping speed exceeds a first swiping speed threshold, a voice input function can be triggered and a voiced search term received. The first swiping speed may trigger a search within the currently-displayed material. When the swipe exceeds a second swiping speed threshold, a voice input function can be triggered and a voiced search term received. The second swiping speed may trigger a search within all messages in, for example, a message inbox. In other words, the swiping speed may be mapped to what to search as well (e.g., a first swiping speed searches a displayed photo album, while a second swiping speed searches a whole photo gallery (search across multiple photo albums).

The direction of the swipe can also be part of the factor to determine what to search. For example, if a swiping speed exceeds a threshold and the direction of swipe is upward, a search from the beginning of the list may be executed. If a swiping speed exceeds a threshold but the direction of swipe is downward, a search beginning at the bottom of the list may be executed.

Table below showing one example on photo gallery app of having different search criteria based on a velocity of the swiping gesture (speed & direction):

TABLE 1
Search based on Swiping Speed

| Scrolling Velocity (Domain) | | | |
|---|---|---|---|
| | | Scrolling | |
| Scrolling Speed | | Direction | Voice Input Stages |
| Speed <2 | cm/seconds | Not | Voice Input Inactive (normal |
| | | applicable | scrolling operation) |
| Speed >2 | cm/seconds | Upwards | Voice Input Activated. Search |
| | | | from the beginning of the list in |
| | | | the displayed photo album and |
| | | | display the first search result. |
| Speed >2 | cm/seconds | Downwards | Voice Input Activated. Search |
| | | | from the bottom of the list in the |
| | | | displayed photo album and |
| | | | display the first search result. |
| Speed >3 | cm/seconds | Upwards | Voice Input Activated. Search |
| | | | from the beginning of the album |
| | | | list within the whole |
| | | | photo gallery across all albums |
| | | | and display the first search |
| | | | result. |
| Speed >3 | cm/seconds | Downwards | Voice Input Activated. Search |
| | | | from the bottom of the album |
| | | | list within the whole photo |
| | | | gallery across all albums and |
| | | | display the first search result. |

As is known in the art, touch screen 201 is capable of displaying material that the user may interact with. The material may be stored in memory 204, and retrieved by logic circuitry 202. Material may take the form of a digital paper-like rectangle that represents a “window” into a document, form, or design area.

Finally, natural-language processor (NLP) 203 comprises well known circuitry that along with logic circuitry 202, analyzes, understands, and derives meaning from human language in a smart and useful way. By utilizing NLP/logic circuitry, voice to text conversion, automatic summarization, translation, named entity recognition, relationship extraction, sentiment analysis, speech recognition, and topic segmentation can take place. In some examples, NLP can simply perform voice to text conversion to convert the received voice data (from microphone) to text and then input the text to logic circuitry 202 to perform the search.

As described above, one problem associated with using touch screens 201 on portable devices is quickly and easily finding an item within material (e.g., a window showing multiple lines/images/text . . . , etc.). In order to address the above-mentioned need logic circuitry 202 will detect a trigger. The trigger preferably comprises a speed of a swipe (a swipe comprises a movement of the fingers across a touch screen). Based on the speed and/or speed of the swipe, logic circuitry 202 will instruct NLP 203 to retrieve a voice input. NLP 203, along with logic circuitry 202 will determine the content of the voice input. The content of the voice input will be used to search the material for the content (by logic circuitry 202) and display any found item in the material on touch-screen display.

As is evident, a swipe speed, or a swipe velocity will be used as a trigger to detect a voice input. A slow swipe may comprise any swipe lower than a predetermined threshold, for example, 2 cm/second, while a fast swipe may comprise any swipe faster that the predetermined threshold.

As is evident, device 200 comprises logic circuitry configured to determine that a user has made contact to touch screen by swiping the touch screen, determine a speed or velocity of the swipe, map the speed or velocity of the swipe to a voice-input state, wherein the voice-input state indicates whether or not to receive a voiced search term, receive a voice input comprising a search term, determine the search term from the voice input, and search material for the search term. A touch screen is provided, and configured to display the material on the touch screen at a point showing the search term.

As discussed, the logic circuitry determines that the user has made contact to the touch screen by determining that the user has made contact to the touch screen within the material displayed on the touch screen.

In one embodiment of the present invention, when a swiping speed has exceeded a threshold and thus triggered a voice input state, a visual indication (for example, showing a particular icon on the display user interface), audio indication (for example, outputting a “beep” sound through device speaker, or haptic feedback (for example, generate a vibration through device vibrator) is generated to inform a user that a voice input state has been triggered. When searches of multiple types are performed, a different indication can be feedback to the user to inform user which state has been triggered (for example, a “beep” sound to indicate a search within a displayed photo album, a “beep beep” sound to indicate a search within a photo gallery across multiple photo albums).

In one embodiment of the present invention, if a voice input state has been triggered, a subsequent detection of a touch/contact from user (e.g. user touches the screen to stop the scrolling list from continue scrolling in order to view the material or when user has found something interest the user in the material), the search can be terminated.

In one embodiment of the present invention, the logic circuitry starts searching from a point in the material where the user begins the fast scrolling gesture, rather than starting the search from the beginning or bottom of the material.

FIG. 3 is a flow chart showing operation of the device of FIG. 2. The logic flow begins at step 301 where logic circuitry 202 determines that a user has made contact to touch screen by swiping the touch screen. At step 303, logic circuitry 202 determines a speed or velocity of the swipe is above a predetermined threshold and initiates voice-input circuitry when the speed or velocity of the swipe is above the predetermined threshold (step 305). In other words, at step 305 logic circuitry 202 (along with NLP 203) are configured to receive a voice input when the swipe speed is above the predetermined threshold. A voice input is then received at step 307, the voice input comprising a search term. Logic circuitry 202 (utilizing NLP 203) determines the search term from the voice input (step 309) and searches material for the search term (step 311).

As mentioned above, the speed and direction of the swipe (velocity) can trigger different searches (e.g., what text/documents/images are searched).

It should be noted that logic circuitry 202 and NLP 203 may be implemented in a single processor. Additionally, the step of determining that the user has made contact to the touch screen may comprise the step of determining that the user has made contact to the touch screen within the material displayed on the touch screen (e.g., within a list displayed on the touchscreen). Finally, logic circuitry 203 causes the material to be displayed on the touch screen at a point showing the search term (the search term may be highlighted by logic circuitry 203).

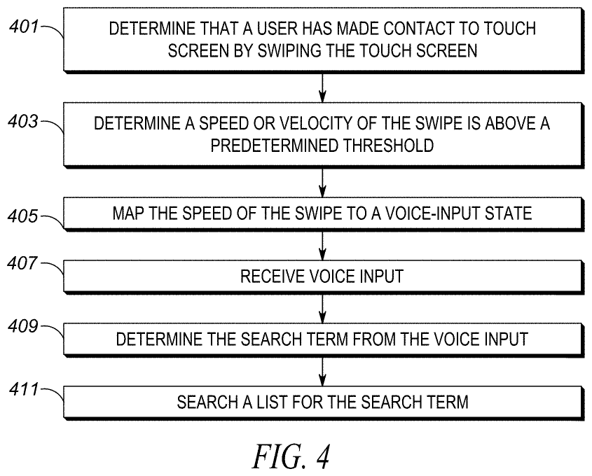

FIG. 4 is a flow chart showing operation of the device of FIG. 2. The logic flow begins at step 401 where logic circuitry 202 determines that a user has made contact to touch screen by swiping the touch screen. At step 403, logic circuitry 202 determines a speed or velocity of the swipe and maps the speed or velocity of the swipe to a voice-input state, wherein the voice-input state indicates whether or not to receive a voiced search term (step 405). Based on the voice-input state, a voice-input is initiated and a voice input is received at step 407, where the voice input comprises a search term and logic circuitry 202 determines the search term from the voice input (step 409). Finally, at step 411, material is searched for the search term.

As discussed, the velocity of the swipe may be used to trigger different searches. For example, the velocity of the swipe may cause different ranges of a document or list to be searched, different search domains, different search hierarchies, different search folders, or different search directions (e.g., search from the top or from the bottom).

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

As discussed, logic circuitry 202 and NLP 203 may be implemented in a single processor. Additionally, the step of determining that the user has made contact to the touch screen may comprise the step of determining that the user has made contact to the touch screen within material displayed on the touch screen. Finally, logic circuitry 203 causes the material to be displayed on the touch screen at a point showing the search term (the search term may be highlighted by logic circuitry 203).

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for performing a search, the method comprising the steps of:
determining that a user has made contact to touch screen by swiping the touch screen;
determining a speed or velocity of the swipe is above a first predetermined threshold or a second predetermined threshold;
initiating voice-input circuitry when the speed or velocity of the swipe is above the predetermined threshold and the second predetermined threshold;
receiving a voice input comprising a search term;
determining the search term from the voice input;
searching first material for the search term when the swipe speed is above the first predetermined threshold; and
searching second material for the search term when the swipe speed is above the second predetermined threshold, wherein the first and the second material differ from each other.

2. The method of claim 1, wherein the step of determining that the user has made contact to the touch screen comprises the step of determining that the user has made contact to the touch screen within the material displayed on the touch screen.

3. The method of claim 2, further comprising the steps of:
displaying the material on the touch screen at a point showing the search term within the material.

4. The method of claim 2, wherein the material comprises a list, a document, an image, a video, a file folder, or thumbnails.

5. The method of claim 2, wherein the step of searching the material comprises the step of searching a particular part of the material based on the velocity of the swipe.

6. The method of claim 2, wherein the step of searching the material comprises a step of searching the material in a direction that is based on a direction of the swipe.

7. A method for searching a list, the method comprising the steps of:
determining that a user has made contact to touch screen by swiping the touch screen;
determining a speed or velocity of the swipe;
mapping the speed or velocity of the swipe to a voice-input state, wherein the voice-input state indicates whether or not to receive a voiced search term;
receiving a voice input comprising a search term;
determining the search term from the voice input;
searching first material for the search term when the swipe speed is above a first predetermined threshold; and
searching second material for the search term when the swipe speed is above a second predetermined threshold, wherein the first and the second material differ from each other.

8. The method of claim 7, wherein the step of determining that the user has made contact to the touch screen comprises the step of determining that the user has made contact to the touch screen within the material being displayed on the touch screen.

9. The method of claim 7, further comprising the steps of:
displaying the material on the touch screen at a point showing the search term.

10. The method of claim 7, wherein the material comprises a list, a document, an image, a video, a file folder, or thumbnails.

11. The method of claim 7, wherein the step of searching the material comprises the step of searching a particular part of the material based on the velocity of the swipe.

12. The method of claim 7, wherein the step of searching the material comprises a step of searching the material in a direction that is based on a direction of the swipe.

13. An apparatus comprising:
logic circuitry configured to:
determine that a user has made contact to touch screen by swiping the touch screen;
determine a speed or velocity of the swipe;
map the speed or velocity of the swipe to a voice-input state, wherein the voice-input state indicates whether or not to receive a voiced search term;
receive a voice input comprising a search term;
determine the search term from the voice input; and
search first material for the search term when the swipe speed is above a first predetermined threshold search second material for the search term when the swipe speed is above the second predetermined threshold; and
a touch screen configured to display the material on the touch screen at a point showing the search term.

14. The apparatus of claim 13, wherein the logic circuitry determines that the user has made contact to the touch screen by determining that the user has made contact to the touch screen within the material being displayed on the touch screen.

15. The apparatus of claim 13, wherein the material comprises a list, a document, an image, a video, a file folder, or thumbnails.
